(19) United States
(12) Patent Application Publication
(10) Pub. No.: US 2010/0032867 A1
(43) Pub. Date: Feb. 11, 2010

(54) Method and apparatus for embossing non woven webs

(75) Inventor: Bradley G. Schmidt, Green Bay, WI (US)

Correspondence Address: RYAN KROMHOLZ & MANION, S.C., POST OFFICE BOX 26618, MILWAUKEE, WI, 53226, US

(73) Assignee: MIDWEST SPECIALTY PRODUCTS, LLC.

(21) Appl. No.: 12/459,257

(22) Filed: Jun. 29, 2009

Related U.S. Application Data
(60) Provisional application No. 61/133,262, filed on Jun. 27, 2008.

(51) Int. Cl. B29C 59/04

(52) U.S. Cl. 264/293

(57) ABSTRACT

A method of embossing an air-laid or double recrepe absorbent fabric including: providing a web of fabric; moving the web material along a web material path; providing a rotary embossing roller and a cooperating backing roller, the rotary embossing roller having a hard rubber embossing surface having a laser engraved embossing pattern with a depth of from about 0.010 inches to about 0.040 inches; providing a nip between the rotary embossing roller and backing roller; moving the web material through the nip between the rotary embossing roller and backing roller whereby a predetermined pattern is embossed on the web material. The embossing roller surface is biased toward the surface of the smooth backing roller. The surface of the backing roller being composed of a soft rubber compound having a durometer hardness of between 20 to 60.

### RELATED APPLICATIONS

This application claims the benefit of U.S. Provisional Patent Application Ser. No. 61/133,262, filed 27 Jun. 2008, and entitled “Method for Permanent Embossing of Non-Woven Webs.”

### BACKGROUND OF THE INVENTION

1. Technical Field

The present invention relates to embossing of non-woven webs and more particularly, to the permanent post-embossing of air-laid or double recrepe (DRC) fabrics. The method utilizes a hard, durable, raised emboss pattern roller and a soft, smooth, rubber backup emboss roller. The present invention further relates to an apparatus and method for embossing non-woven web material.

2. Background Art

Air-laid and DRC sheets are well known in the art. The following is a description of some illustrative patents.

1. U.S. Pat. No. 7,208,064 (Schmidt et. al.) describes a method for embossing air-laid webs using laser engraved, heated embossing rolls. The preferred use of these rolls is on the production line to thereby reduce cost and shorten emboss pattern development time.

2. U.S. Pat. No. 5,759,473 (Minke et. al). describes a process for producing a silicone coated embossing roll used for embossing a thermo-plastic film. A laser beam is used to cut a pattern in the smooth silicone rubber roll.

3. U.S. Pat. No. 5,529,563 (Veith et. al.) describes a method of embossing between unmatched male and female embossing elements wherein one of the rolls could be made of rubber.

4. U.S. Pat. No. 5,269,983 (Shultz) describes a method of embossing using a mated pair of emboss rolls whereby a laser can be used to make recesses in a resilient roll which, in turn, receives the protuberances of a rigid male embossing roll when nipped together.

5. U.S. Pat. No. 4,476,078 (Tao) describes conventional embossing either before or after binder is applied and cured. As described, each method has its advantages and disadvantages, with pre-embossing reducing production line speed, and post-embossing lacking good emboss clarity.

As is seen in the foregoing, rubber rolls have been used for embossing in pre and post production or binder in application. However, each known application has shortcomings. Typically, post emboss application methods produce results which suffer from lack of emboss definition or lack of emboss permanence, particularly on non-woven webs, such as air-laid web. To date, there has been no progress in the clear and permanent post embossing of non-woven air-laid or DRC webs.

The method of present invention ameliorates the shortcomings of known methods by providing clearly defined, permanent emboss patterns during post production handling of air-laid or DRC web. The present method produces a deeper emboss impression than that of previous methods, with the deeper impression maintaining itself over time, rather than flattening and losing definition. Further, the present method reduces costs through the use of rubber male and smooth rubber backup emboss rollers. In addition, pattern development time and emboss roller engraving is both less costly and less time consuming.

### SUMMARY OF THE INVENTION

There is provided in accordance with the present invention, a method for permanent embossing non-woven, air-laid and DRC substrates in a continuous inline process. The inventive process includes: A) selecting a predetermined air-laid or DRC web for post embossing; B) providing a hard engraved emboss roller having a continuous, circumferential, hard embossing surface; C) providing the embossing surface with a predetermined pattern engraved thereon, the pattern having a height of 0.010 inches to about 0.040 inches; D) biasing the hard embossing surface toward a second, smooth backup roller; E) providing the smooth backup roller with a continuous surface composed of a soft rubber compound, the compound having a durometer hardness of 20 to about 60; and F) nipping a web of predetermined substrate between the two rolls at pressures of 50 to 500 pli to thereby emboss the web.

It is to be understood that the emboss pattern selection is critical to thereby minimize the amount of emboss area on the web and to maintain the original overall packaged product thickness. Further, the predetermined emboss pattern selected for emboss use should preferably have a raised emboss surface of about 0.5 percent to 35 percent of the emboss roller total surface area.

This process may also be adapted for use in discontinuous processes without departing from the spirit of the invention. Other modifications to this invention could also be readily acknowledged by experts in this field, however they should be considered within the scope of this invention.

### BRIEF DESCRIPTION OF THE DRAWINGS

FIG. 1 is a schematic view of the apparatus illustrating the general relationship of the cooperating elements.

FIG. 2 is a fragmentary side view of the feed end of the apparatus.

FIG. 3 is a fragmentary, schematic view showing the embossing section of the apparatus.

FIG. 4 is a fragmentary view showing the embossing section of the apparatus.

FIG. 5 is a perspective view of an embossing roller and backing roller according to the present invention.

FIG. 6A is a cross sectional view of the rollers shown in FIG. 5 and taken along line 6A-6A thereof, and showing a steel embossing roller.

FIG. 6B is an enlarged view of a portion of FIG. 6A and illustrating the embossing surface.

FIG. 7A is a cross sectional view of the rollers shown in FIG. 5 and taken along line 7A-7A thereof, and showing an embossing roller having rubber surface.

FIG. 7B is an enlarged view of a portion of FIG. 7A and illustrating the embossing surface.

FIG. 8A is a cross sectional view of the rollers shown in FIG. 5 and taken along line 8A-8A thereof, and showing an embossing roller having a sleeve and a coating.

FIG. 8B is an enlarged view of a portion of FIG. 8A and illustrating the embossing surface.

FIG. 9 is a perspective view of the sheet guide and tension control section of the apparatus.

FIG. 10 is a fragmentary view showing a web embossed according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

The present invention is directed to a method of post-embossing non-woven, air-laid or DRC web. The present method does not significantly affect the overall bulk and strength of the base fabric web, thereby maintaining the original overall packaged product thickness. The method further enhances separation and dispensing of the finished product.

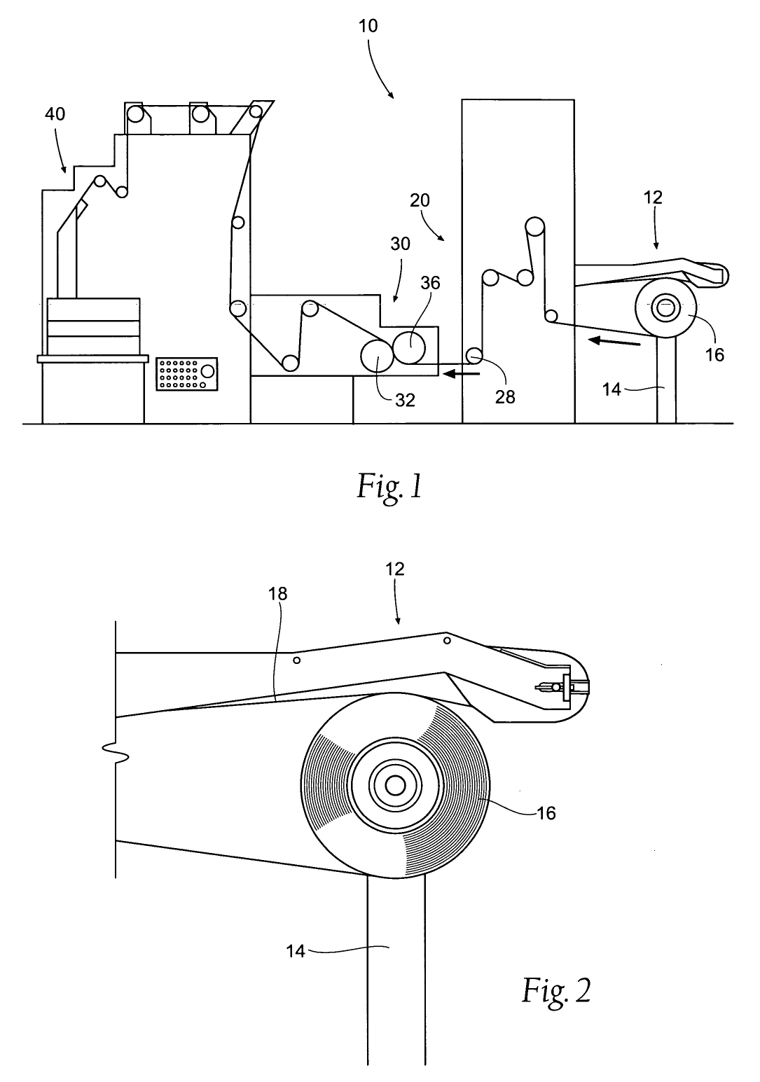

An apparatus which may be used to practice the present method may be viewed in FIGS. 1-9. As seen particularly in the view of FIG. 1, the apparatus 10 may include an infeed section 12, a sheet guide and tension control section 20, an embossing section 30, and a folding and cutting section 40. With reference to FIG. 2, the infeed section 12 may include an unwind stand 14 to support and feed rolled non-woven web product 16, such as air-laid or DRC web on a sheet path into the apparatus 10. The web 16 is moved from the unwind stand 15 toward the embossing section 30 by way of a belt 18 and sheet guide system 20 toward the embossing section 30.

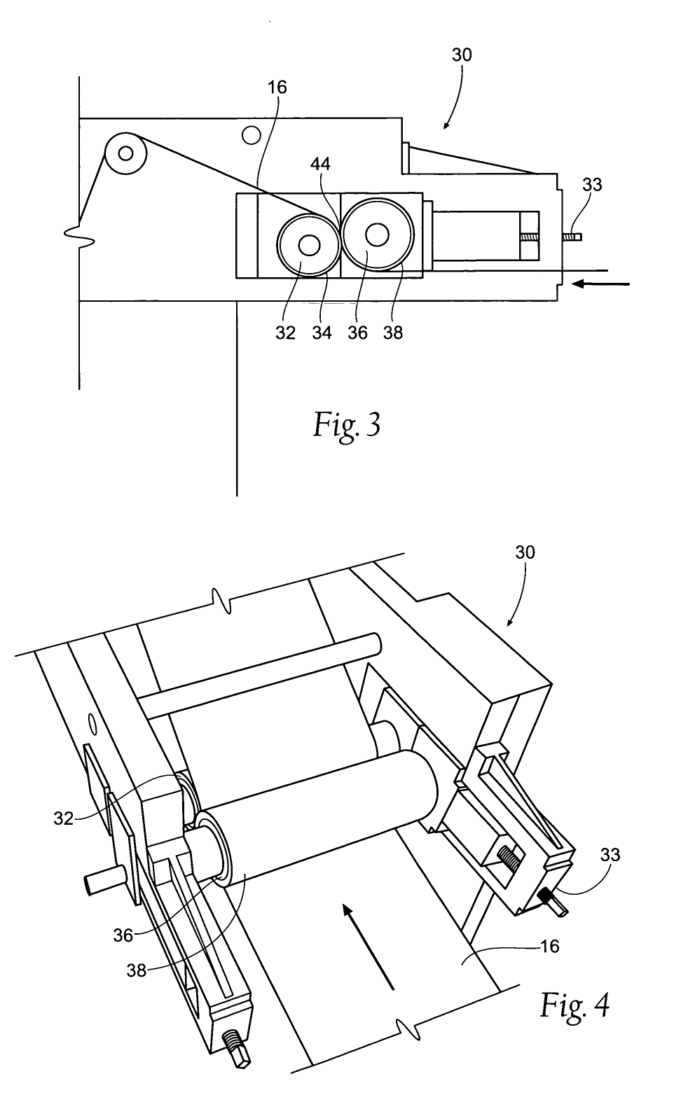

FIG. 3 illustrates a schematic view of the embossing section 30 and showing a web 16 positioned for embossing. As seen, the embossing section 30 includes an embossing roller 32 having a continuous circumferential emboss surface 34, and a smooth soft rubber backup roller 36 having a continuous surface 38; the smooth soft rubber backup roller 36 being in cooperating rotational movement with the embossing roller 32. The embossing section 30 may further include drive means (not shown) and at least one idler roller 28 to support the web material 16 preceding a nip 44 between the rotary embossing roller 32 and the smooth soft rubber backup roller 36. Although not shown, the drive means may include known drive means such as a stepper motor connected to a differential drive unit, the differential drive unit being connected to the smooth soft rubber backup roller 36, and gearing or other conventional drive means for driving the embossing roller 32, to thereby correct variation in web alignment relative to the rotary embossing roller 32.

As may be further viewed in FIG. 4, embossing pressure may be adjusted by biasing means, such as the threaded members 33 shown. A preferred hard, raised embossing roller 32 may be made of steel or steel covered in hard rubber. The raised embossing roller 32 is preferably provided with a circumferential, continuous emboss surface 34 having a minimum durometer of approximately 50. The engraved rubber roll emboss surface 34 preferably has a durometer hardness of approximately 50 to 100, with a durometer hardness of 70 to 97 being typical. However, most preferably, the hard rubber roll surface 34 has a durometer hardness from about 90 to 95.

As may be seen in FIGS. 6A, 7A, and 8A, at least one raised emboss pattern 42 is provided on the continuous circumferential surface 34. The pattern 42 corresponds to a predetermined embossing configuration. The pattern 42 extends radially from the circumferential surface 34 to a predetermined height (H), and is preferably engraved at a depth of about 0.010 inches to 0.090 inches, with a depth of 0.015 inches to 0.050 inches being typical. The preferred method has an engraved depth of 0.020 inches to 0.040 inches in most applications.

As may be observed in FIG. 4, web material 16 is moved toward a nip 44 between the rotary embossing roller 32 and smooth soft rubber backup roller 36 whereby the predetermined embossing pattern 42 is embossed in the web material 16. The embossing design 42 of the raised embossing roller 32 may be repeatable and is preferably laid out in such a manner that the design 42 area which is in contact with the surface 38 of the smooth soft rubber backup roller 36 is substantially constant during operation. When contact between the design 42 area and surface 38 remains stable during operation, constant pressure at the nip 44 results, which minimizes roller 32, 36 bounce. The embossing design 42 may cover about 0.5 percent to 30 percent of circumferential surface 34 of the raised embossing roller 32. However, a preferred embossing design 42 of the present invention may cover about 1 percent to 10 percent of the circumferential surface 34, with 1.5 percent to 5 percent of the circumferential roller surface 34, being optimal.

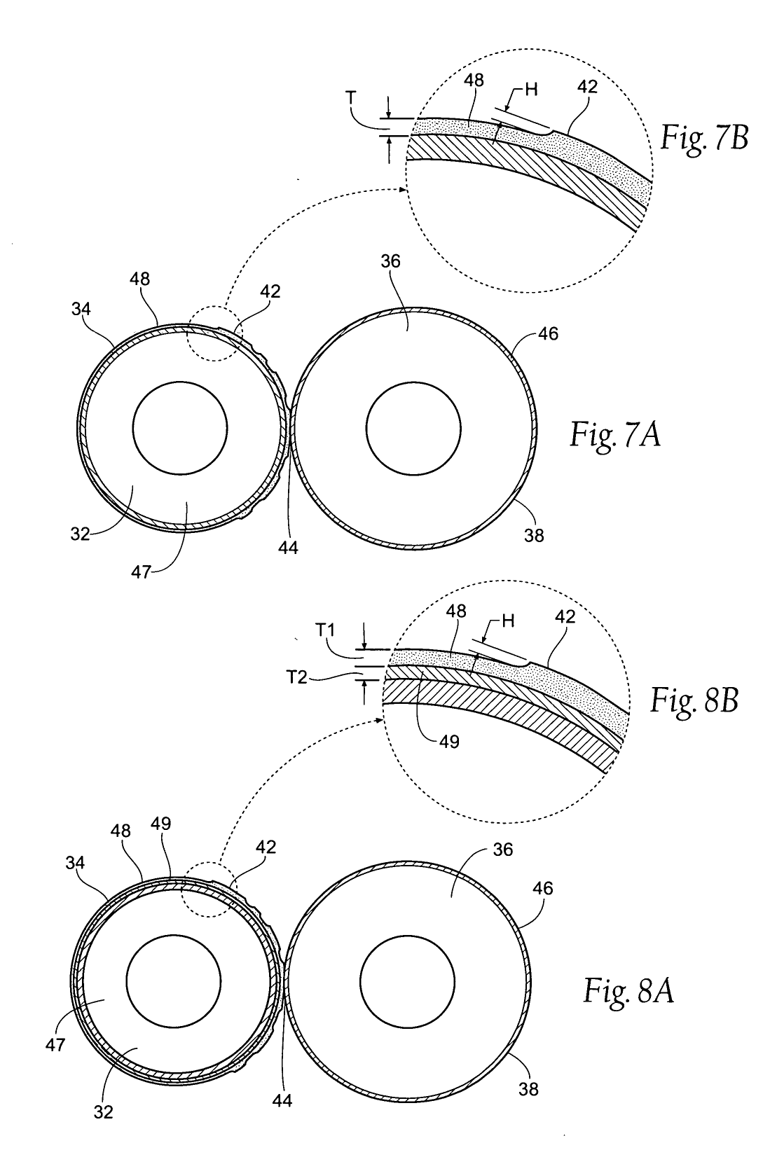

Alternative embodiments of a hard raised embossing roller 32 for use in the present method may be viewed in FIGS. 6A, 7A, and 8A. A hard raised embossing roller 32 used in a preferred method may be steel (see FIG. 6A), steel covered with a hard rubber surface 48 (see FIG. 7A), or steel covered with a sleeve 49 having a rubber coating 48 (see FIG. 8A).

As viewed particularly in FIGS. 7A and 7B, the rubber coating 48 may have a thickness (T) of about 0.030 inches to about 1 inch. Alternatively, the thickness of rubber coating 48 may be about 0.200 inches to 0.750 inches. Another embodiment may include a thickness of rubber coating 48 to be approximately 0.450 inch. The hard rubber surface preferably has a durometer hardness of about 50 to 100, but may be between about 70 to 97, or even about 90 to 95.

An alternative hard raised emboss roller 32 may be viewed in FIGS. 8A and 8B, where the raised emboss roller 32 includes a steel roll 47 covered with a sleeve 49 having a predetermined thickness (T2), and wherein the sleeve 49 is covered with a rubber coating 48 having a predetermined thickness (T1) of about 0.030 inches to 1 inch. Alternatively, the sleeve 49 may be covered with about 0.200 inches to 0.750 inches of rubber coating 48. In another alternative, the sleeve 49 may be covered with 0.450 inches of coating 48.

In a preferred method according to the present invention, the hard emboss roller 32 may be traditionally engraved by tooling and acid etching. Alternatively, the engraving may be made by laser. The depth (H) of the engraved pattern roll may be from about 0.010 inches to about 0.090 inches, about 0.015 inches to about 0.050 inches, or about 0.020 to about 0.040 inches.

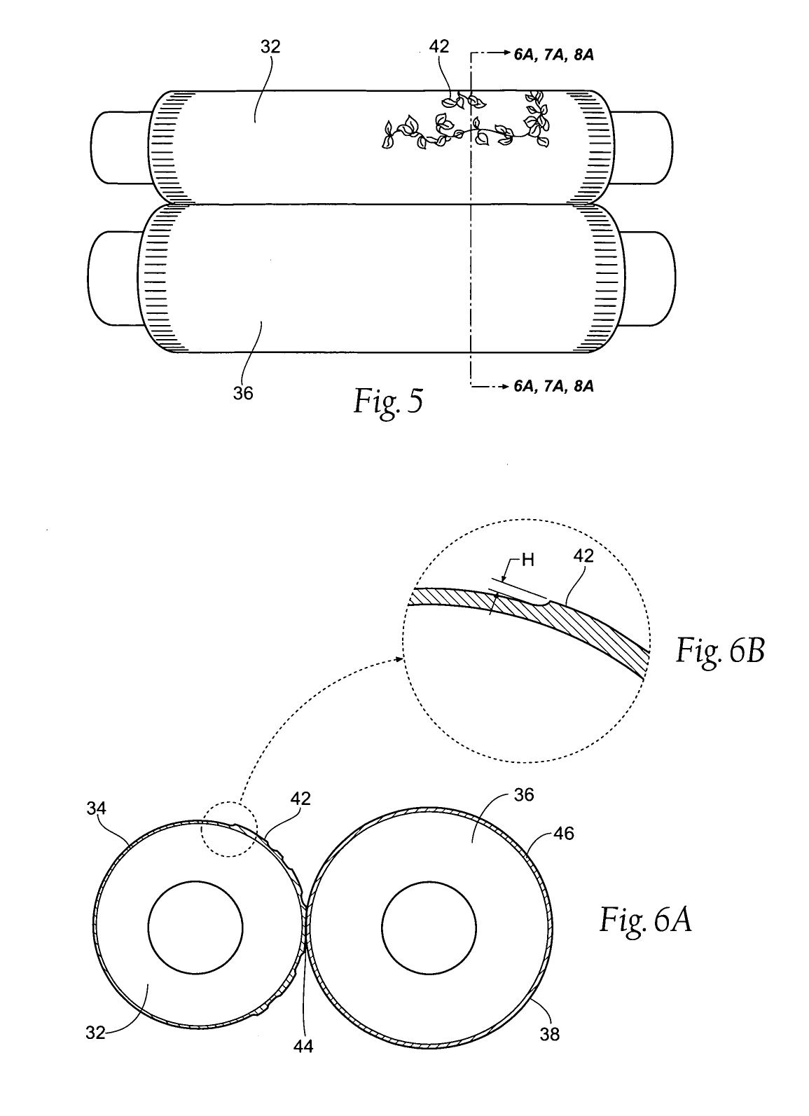

With further reference to FIGS. 5, and 6A-8C, a preferred smooth soft rubber backup roller 36 may be seen. The smooth soft rubber backup roller 36 is preferably provided with a continuous surface 38 having a durometer hardness of 20 to 60, with a surface durometer hardness reading of 30 to 50 being typical. The most preferred soft rubber surface has a durometer hardness of 35 to 45. A smooth soft rubber backup roller 36 in accordance with the present method is preferably fabricated of steel having a rubber covering 46 of a predetermined thickness, wherein the rubber covering 46 is greater than 0.030 inches thick. Alternatively, the rubber covering 46 may be greater than 0.250 inches thick, or may even be greater than 1.0 inches thick.

It is to be understood that it is also possible to heat the raised hard emboss roller 32, the smooth soft rubber backup roller 36, or both, without departing from the spirit of the invention. Heating the rollers 32 or 36 allows for lower pounds per linear inch on the emboss rolls or faster throughput, with comparative emboss definition. Further, it is also possible to utilize the disclosed apparatus and method in an inline process.

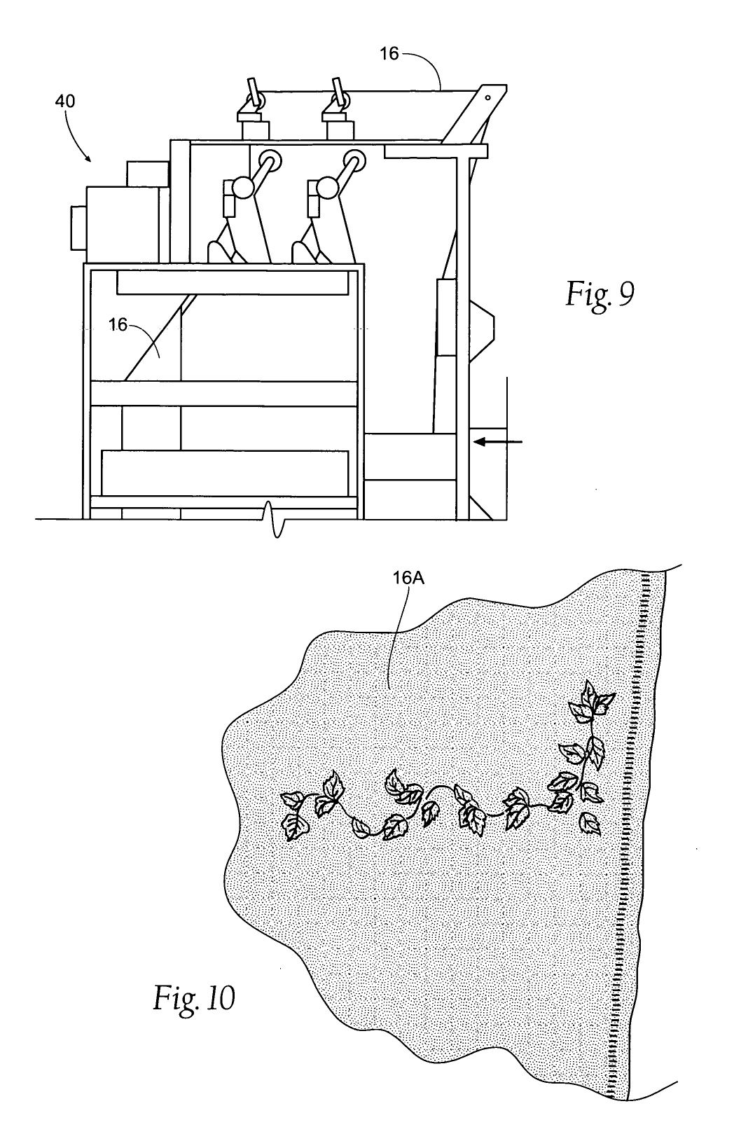

While the inventive method of the present invention may be applied to any air-laid or DRC substrate, it is understood that most typically these substrates have basis weight from about 25 to about 200 pounds per 3000 square foot ream. Most preferably the basis weight of the substrate is approximately 28 pounds to 60 pounds per 3000 square foot ream. Further, the process described can be applied to webs made using other non woven technologies or materials, including, but not limited to, McAirlaid, Brettings point to point emboss product, and hydroentangled fabrics. Further, it is to be understood that post emboss handling of the substrate may include sheet folding and cutoff prior to discharge and packaging, such as that shown in FIG. 9. FIG. 10 depicts an embossed substrate 16A according to the method of the present invention.

A method according to the present invention includes the steps of: A) selecting a predetermined air-laid or DRC web roll for post embossing; B) providing a hard, raised emboss roller 32 having a continuous, circumferential, hard embossing surface 34; C) providing the embossing surface 34 with a predetermined pattern 42 engraved thereon, the pattern 42 having a depth of 0.010 inches to about 0.040 inches; D) biasing the hard embossing surface 34 toward a second, smooth soft rubber backup roller 36 to thereby provide a nip 44; E) providing the second smooth soft rubber backup roller 36 with a continuous surface 38 composed of a soft rubber coating 46, the coating having a durometer hardness of 20 to about 60; and F) nipping a web 16 of predetermined substrate between the two rolls 32, 36 at pressures of 50 to 500 pli to thereby emboss the web 16. The method may further include the step of providing the hard, raised emboss roller 32 with a repeatable, predetermined pattern 42 which is arranged and employed in a manner to not significantly affect the overall substrate 16 thickness or strength.

Another method of embossing air-laid sheet product according to the present invention may comprise the steps of:

a) providing a base sheet 16 of pre-formed air-laid composed of binder and pulp; and

b) embossing said sheet 16 by nipping it between a hard, raised emboss roller 32, and a smooth soft rubber backup roller 36.

The process results in minimal change in overall sheet performance and physical properties due to the emboss depth and coverage.

A binder used in a preferred method may be composed of any one or combination of the following:

a) liquid polymer emulsions, ethylene vinyl acetate, vinyl acetate, acrylic, styrene butadiene, etc.

b) thermal bondable fiber or powders such as polyethylene, polypropylene, or mixtures thereof, by way of example.

Pulps used in a preferred method may be composed of any one or combination of the following: wood pulp, synthetic fibers including polyethylene, polypropylene, nylon, rayon, acrylic, by way of non-limiting example.

As mentioned previously, the present invention may also define a preferred method of embossing double recrepe (DRC) sheet product. A preferred method may comprise the steps of:

a) providing a base sheet 16 of pre-formed DRC;

b) embossing said sheet 16 by nipping it between a hard, raised emboss roller 32, and a smooth soft rubber backup roller 36.

The process results in minimal change in overall sheet performance and physical properties due to emboss depth and coverage.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. A method of embossing a predetermined substrate including the steps of:
selecting a predetermined substrate for post embossing;
providing a hard, raised embossing roller, said embossing roller having a continuous circumferential surface, said surface having a predetermined durameter hardness;
providing said circumferential surface with a predetermined embossing pattern thereon, the pattern extending radially from the circumferential surface to a predetermined height;
providing a second, smooth soft rubber backup roller;
biasing the hard embossing surface toward said second, smooth soft rubber backup roller to thereby provide a nip;
providing the second smooth soft rubber backup roller with a continuous surface and
nipping said predetermined substrate between the embossing roller and the backup roller at a predetermined pressure to thereby emboss the substrate.

2. The method of claim 1, wherein said pattern has a height of 0.010 inches to 0.090 inches.

3. The method of claim 1, wherein said pattern has a height of 0.015 inches to 0.050 inches.

4. The method of claim 1, wherein said pattern has a height of 0.020 inches to 0.040 inches.

5. The method of claim 1, wherein the selected substrate is an air-laid web.

6. The method of claim 1, wherein the selected substrate is a DRC web.

7. The method of claim 1, wherein said continuous surface of said second smooth soft rubber backup roller is composed of a rubber coating, the coating having a durometer hardness of 20 to 60.

8. The method of claim 1, wherein said continuous surface of said second smooth soft rubber backup roller is composed of a rubber coating, the coating having a durometer hardness of 30 to 50.

9. The method of claim 1, wherein said continuous surface of said second smooth soft rubber backup roller is composed of a rubber coating, the coating having a durometer hardness of 35 to 45.

10. The method of claim 1, wherein said predetermined pressure is between 50 to 500 pli.

11. The method of claim 1, wherein said predetermined hardness is between durameter 50 to 100.

12. The method of claim 1, wherein said predetermined hardness is between durameter 70 to 97.

13. The method of claim 1, wherein said predetermined hardness is between durameter 90 to 95.

14. The method of claim 1 further including the step of providing said embossing roller with a coating, said coating having a predetermined thickness, wherein said thickness is between 0.030 to 1.000 inches.

15. The method of claim 1 further including the step of providing said embossing roller with a sleeve, said sleeve being covered with a coating, said coating having a predetermined thickness, wherein said thickness is between 0.030 to 1.000 inches.

16. The method of claim 1 wherein said predetermined pattern is repeatable.
